(19) United States
(12) Patent Application Publication
(10) Pub. No.: US 2003/0013491 A1
(43) Pub. Date: Jan. 16, 2003

(54) Portable terminal device having outgoing call control and personal data access control

(75) Inventor: Takashi Moriki, Kanagawa (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/193,308

(22) Filed: Jul. 12, 2002

(30) Foreign Application Priority Data
Jul. 16, 2001 (JP) 214651/2001

(51) Int. Cl. H04M 1/00

(52) U.S. Cl. 455/564; 455/419; 455/550

(57) ABSTRACT

A data storage system is connected to a public line network through a modem, and is provided with a personal computer operated by a user. The personal computer can establish communications between a base station and a lost mobile phone. Permission data for outgoing call control and protection of personal data is entered in the lost mobile phone. It is determined whether or not the permission data matches a request data from the personal computer. When they match each other, the personal data pulled out of the lost mobile phone is stored in the personal computer. The personal data can be transferred by connecting a substitute mobile phone through a connection cable.

### BACKGROUND OF THE INVENTION

1. Field of the Invention

The present invention relates to a portable terminal device. More particularly, the present invention is directed to a wireless portable terminal device having outgoing call control and/or personal data access control to prevent unauthorized access and/or browsing of personal data stored on the portable terminal device.

2. Description of the Related Art

Portable terminal devices and mobile phones, which are generally referred to as a “PHS” and “cell phone,” are small and lightweight, and are provided with various additional functions, and they have made remarkable progress and are practically replacing the conventional cable telephone system.

Mobile phones have not only a basic communications function, but also a telephone book function, an outgoing call history entry function, an incoming call history entry function, a memo recording function, etc. Generally, a user's personal data are stored in a memory in advance to carry out the above functions. And then, the user, by handling the operation button(s), can fetch the contents of the memory at any time.

Moreover, mobile phones typically have a locking dial function to prevent billing the owner of the mobile phone for an unauthorized outgoing call made by a person other than the owner when the mobile phone is stolen or lost. The function also prohibits them from browsing personal data stored in the memory.

This dial lock capability can be set by the owner of the mobile phone by registering his or her password in the mobile phone, and pressing a specific operation button, e.g., pressing a function key for a prolonged time. The dial lock can be released by inputting the registered password, and pressing the specific operation button, e.g., pressing the communications button for a prolonged time.

Although an unauthorized outgoing call or unauthorized browsing of personal data can be almost completely deleted by constantly using the above mentioned dial lock, and releasing the lock each time communications are started, setting a dial lock and releasing the lock each time communications are started is time-consuming, and therefore not performed. Therefore, when a mobile phone is stolen or lost, there is the possibility that a person other than the owner uses the mobile phone without authorization, thereby causing financial damage and unauthorized browsing through personal data.

Therefore, as disclosed in Japanese Patent Laid-Open No. 2000151798, a signal code for controlling outgoing call and for prohibition against browsing personal data is entered in advance in the body of a mobile phone. The lost mobile phone is called from a subscribed phone or another mobile phone through an exchange system. A request code is transmitted with a communications circuit established, and outgoing call control is executed and memory data is locked when the signal code of the lost mobile phone matches the request code. Simultaneously, the personal data is pulled out by the equipment such as the personal computer, etc. connected to a telephone line as necessary, and then the personal data stored on the lost mobile phone is deleted.

The above mentioned case can also be applied not only to a lost mobile phone, but also to all portable terminal devices such as mobile personal computers or personal digital assistants having the communication functions.

The conventional portable terminal device can lock an operation key or personal data to prevent an unauthorized use or unauthorized leakage of personal data by a third party using stolen or lost equipment only after a communications channel circuit is established. That is, the above mentioned process can only be performed when an answer is returned in response to a call to a stolen or lost portable terminal device. However, it is not likely that a third party will answer the call to the stolen or lost equipment. Therefore, the condition of possibly issuing an unauthorized outgoing call and browsing personal data still continues. As a result, a countermeasure is only to issue a request an exchange center to reject an outgoing call, and to perform the outgoing call rejection by the exchange center, thereby having no means for prohibition against browsing personal data.

### SUMMARY OF THE INVENTION

The present invention is devised in view of the above-described problems. It is an aspect of the invention to provide a portable terminal device capable of controller an outgoing call from stolen or lost portable terminal device with reliability without requesting an answer from the unauthorized user or requesting an exchange center to reject an outgoing call, and capable of prohibiting the unauthorized browsing of personal data.

To solve the above mentioned problems, a mobile terminal device of the present invention comprises a radio means for communicating communications channel data with a radio base station, and for communicating control channel data with the radio base station at an appropriate timing independent of the control channel data. The mobile terminal device also comprises storing means for storing a predetermined information and judging means for judging whether the predetermined information is contained in the control channel data received by the radio means. The mobile terminal device further comprises controlling means for controlling the radio means on the basis of the result of the judging means. The controlling means exerts control over an outgoing call if the predetermined information is contained in the control channel data. The controlling means may prohibit a key operation for issuing a call from the mobile terminal device. The predetermined information is the data that requests outgoing call control. Preferably, mobile terminal device further comprises display means for displaying contents of outgoing call control when it is performed.

Moreover, a mobile terminal device of the present invention comprises radio means for communicating communications channel data with a radio base station, and for communicating control channel data with the radio base station at an appropriate timing independent of the control channel data. The mobile terminal device further comprises storing means for storing a predetermined information and a personal information and judging means for judging whether the predetermined information is contained in the control channel data received by the radio means. The mobile terminal device further comprises controlling means for controlling the personal information on the basis of the result of the judging means. The controlling means transfers a personal information stored in the mobile terminal device if the predetermined information is contained in the control channel data. The personal information is transferred to a personal computer connected to at least a radio channel or a cable channel. The controlling means may prohibit a key operation for reading the personal information. Preferably, the mobile terminal device further comprises display means for displaying contents of data locking when it is performed.

An outgoing call control method of the present invention comprises storing a predetermined information, communicating communications channel data with a radio base station, communicating control channel data with the radio base station at an appropriate timing independent of the control channel data, judging whether the predetermined information is contained in the control channel data and controlling an outgoing call if the predetermined information is contained in the control channel data. The controlling of an outgoing call may prohibit a key operation for issuing a call from the mobile terminal device. The predetermined information is the data that requests outgoing call control. The outgoing call control method of the present invention further comprises displaying contents of outgoing call control when it is performed.

Moreover, an outgoing call control method of the present invention includes storing predetermined information and personal information, and communicating communications channel data with a radio base station. The method further comprises communicating control channel data with the radio base station at an appropriate timing independent of the control channel data, and judging whether the predetermined information is contained in the control channel data. Finally, the method comprises transferring the personal information if the predetermined information is contained in the control channel data. The personal information is transferred to a personal computer connected to at least one of a radio channel or a cable channel. The method further comprises prohibiting a key operation for reading the personal information. The method may comprise displaying contents of data locking when it is performed.

A mobile terminal device of the present invention comprises a radio unit that communicates communications channel data with a radio base station, and that communicates control channel data with the radio base station at an appropriate timing independent of the control channel data. The mobile terminal device further comprises a memory that stores predetermined information, and an analysis unit that judges whether the predetermined information is contained in the control channel data received by the radio unit. The mobile terminal device further comprises a control unit that controls the radio unit on the basis of the result of the analysis unit. The control unit exerts control over an outgoing call if the predetermined information is contained in the control channel data. The control unit may prohibit a key operation for issuing a call from the mobile terminal device. The predetermined information is the data that requests outgoing call control. The mobile terminal device further comprises a display unit that displays contents of outgoing call control when it is performed.

A mobile terminal device of the present invention comprises radio unit that communicates communications channel data with a radio base station, and that communicates control channel data with the radio base station at an appropriate timing independent of the control channel data. The mobile terminal device further comprises a memory that stores predetermined information and personal information, and an analysis unit that judges whether the predetermined information is contained in the control channel data received by the radio unit. The mobile terminal device further comprises a control unit that controls the personal information on the basis of the result of the analysis unit. The control unit transfers a personal information stored in the mobile terminal device if the predetermined information is contained in the control channel data. The personal information is transferred to a personal computer connected to a radio channel or a cable channel. The control unit may prohibit a key operation for reading the personal information. The mobile terminal device further comprises a display that displays contents of data locking when it is performed.

According to the present invention, the portable terminal device of the present invention does not use a communications channel circuit, but uses a control channel circuit when any of outgoing call control, the prohibition against unauthorized browsing of personal data, and the retreival of personal data is performed by remote control. By periodically receiving the control channel, the presence/absence of a request is analyzed, thereby performing control with higher reliability.

That is, when a communications channel circuit is used in the remote control, the control can be interrupted on the base station side depending on the state of the communications traffic. For example, it can be interrupted during the transfer of personal data. Using a control channel, such interruption cannot occur, thereby reserving a circuit with high reliability.

Since remote control is performed by using a control channel without remote control using a communications channel circuit, it is not necessary for an answer from the third party who now holds a stolen or lost equipment, and unauthorized outgoing calls or unauthorized browsing of personal data can be immediately prohibited.

Accordingly, the present invention can provide a portable terminal device capable of performing outgoing call control on a stolen or lost portable terminal device with high reliability without requesting an unauthorized user to return an answer or requesting an exchange center to reject an outgoing call, and capable of prohibiting the unauthorized browsing of personal data without requesting an unauthorized user to return an answer.

### BRIEF DESCRIPTION OF THE DRAWINGS

These and other aspects, features and advantages of the invention will become more fully apparent from the following detailed description taken in conjunction with accompanying drawings. In the drawings:

FIG. 1 shows a configuration of an entire system of a portable terminal device according to an embodiment of the present invention;

FIG. 2 is a block diagram of a circuit of a central portion of a lost mobile phone 1 shown in FIG. 1;

FIG. 3 is a flowchart of the operation of a control channel of the lost mobile phone 1 shown in FIG. 1; and

FIG. 4 is a flowchart of the detailed operations of a data transfer process shown in FIG. 3.

### DETAILED DESCRIPTION OF THE EMBODIMENTS

Hereinafter, each embodiment of the present invention will be described in detail with reference to the drawings.

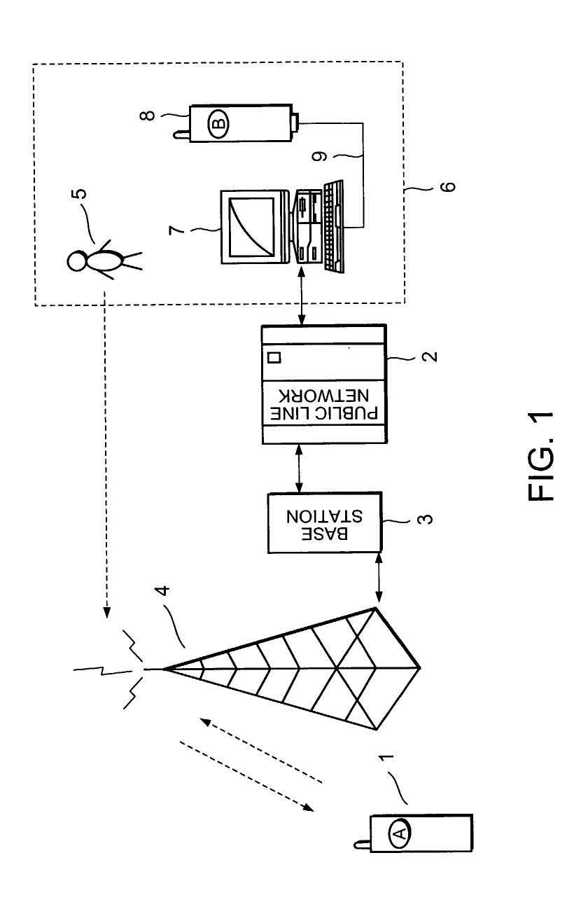

An embodiment is obtained by applying the present invention to a mobile phone, and the entire configuration will be described below by referring to FIG. 1. A lost mobile phone 1 can perform normal communications during power-up, and can be set in a state of browsing telephone book data and incoming/outgoing call history data by a key operation.

The portable terminal device is configured to communicate with a number of mobile phones through an antenna 4 provided in a base station 3 connected via cable to a public line network 2. Practically, the equipment is configured to include radio means capable of communicating communications channel data with base station 3, and capable of communicating control channel data with the base station 3 at an appropriate timing independent of the communications channel data.

On the other hand, a data storage system 6 is connected to the public line network 2 through a modem device, which is not shown in FIG. 1. That is, a personal computer 7 operated by a user 5 is connected to the public line network 2. At a result, communications with the personal computer 7 and both the base station 3 and the lost mobile phone 1 can be established. The personal data can be pulled out from the lost mobile phone 1 (as described later) is temporarily stored in the memory in the personal computer 7. A substitute mobile phone 8 is connected through a connection cable 9, thereby transferring the personal data to the substitute mobile phone 8.

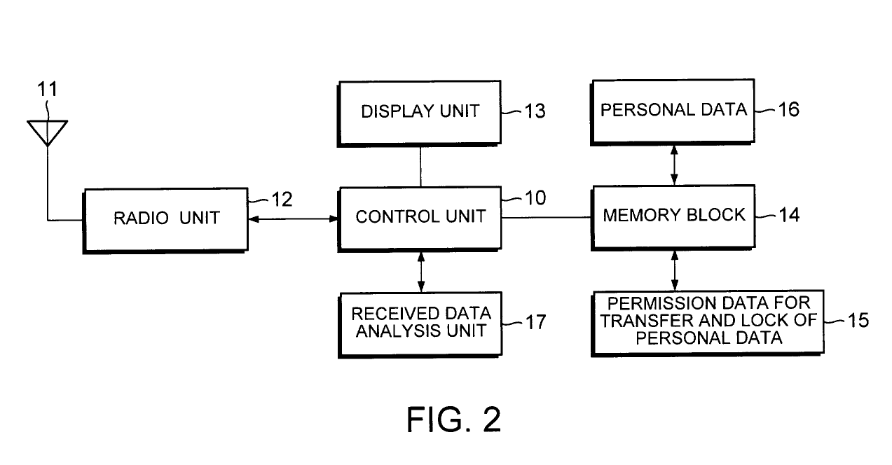

The circuit of the portable terminal device (lost mobile phone 1) according to the present invention is configured as shown in FIG. 2. That is, the equipment is provided with a control unit 10 for combining and controlling the operation of the mobile phone 1, and a radio unit 12 having an antenna 11 is connected to the control unit 10.

The radio unit 12 forms the central portion of radio means capable of communicating communications channel data with the base station 3 through the antenna 11 and the antenna 4, and communicating control channel data at an appropriate timing independent of the communications channel data.

A display unit 13 connected to the control unit 10 is configured to include display means capable of displaying a basic call functions, and displaying the contents of outgoing call control and/or data locking when they are performed.

The equipment data specifying the equipment (lost mobile phone 1), and personal data 16 formed by telephone book data, outgoing call history data, incoming call history data, memo data, etc. is included in a memory block 14 connected to the control unit 10. The transfer permission data for permission of a request to transfer the personal data 16 is registered in the memory block 14, and permission data 15 in which data for permission of a request to lock a dial and memory is registered is included in the memory block 14. Thus, the central portion of the registration means can be configured.

A received data analysis unit 17 connected to the control unit 10 forms determination means. Practically, the determination means compares transfer request data with the transfer permission data of the permission data 15, and determines whether or not they match each other when the control channel data received by the radio unit 12 includes the transfer request data. If the determination means detects a matching result between the transfer request data and the transfer permission data, then control means has the control unit 10 control the radio unit 12 to transfer the personal data 16 to a predetermined destination. The personal data 16 will be transferred to the personal computer 7 of the data storage system 6. The control means also controls the radio unit 12 through the control unit 10 to exert control over an outgoing call when a matching result is detected between the outgoing call control request data and the outgoing call control permission data.

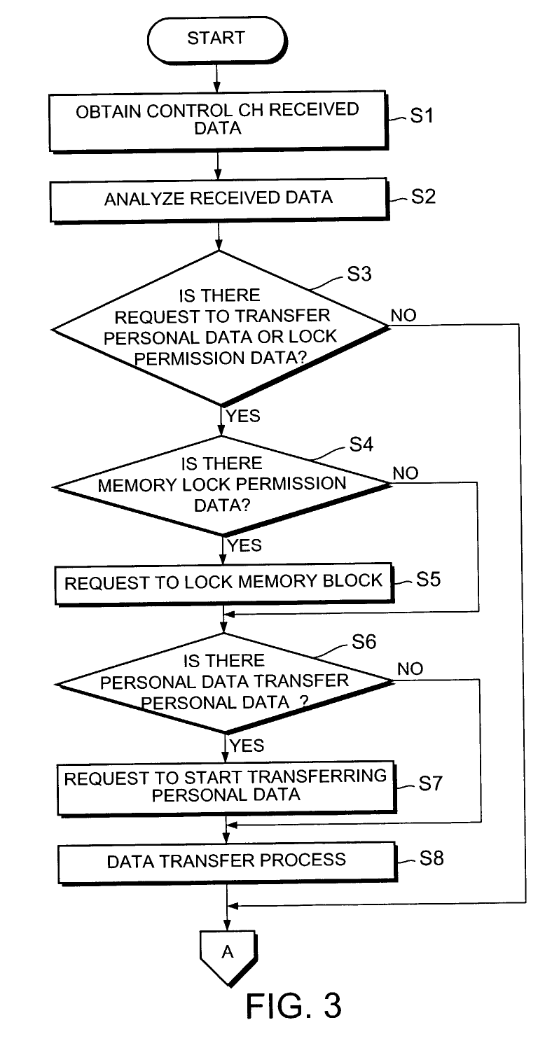

An arrow, shown in FIG. 1 by dotted lines from the user 5 toward to the antenna 4, indicates an electric wave path for remote control of the outgoing call control, prohibition against browsing personal data, and pull-out of personal data on the lost mobile phone 1. User 5 accomplishes this by using another mobile phone. This operation will be described later, and the operation of the personal computer 7 connected to the public line network 2 at the time of performing the remote control will be described below by referring to the flowchart shown in FIG. 3.

The operations described below are performed on the assumption that the lost mobile phone 1 is located in the position where the lost mobile phone 1 can receive an electric wave transmitted through the antenna 4, and that the lost mobile phone 1 is powered up and set in a reception wait state. The outgoing call control operation and the data transfer operation are performed by obtaining data when the control channel data transmitted at an appropriate timing from the base station 3 through the antenna 4 is received by the radio unit 12 of the lost mobile phone 1 at S1. At S2, the received data analysis unit 17 analyzes the data, and then, at S3, the control unit 10 acts accordingly.

At S3, it is determined whether or not the received control channel data includes a request to transfer the personal data 16 or a request for the permission data 15. If there are no such requests (NO), then the process terminates.

On the other hand, if it is determined YES at S3, then at S4, it is determined whether or not there is memory lock permission data. If there is the permission data (YES), then control is passed to S5, where the request to lock the memory block is issued. Control then passed to S6, where it is determined whether or not there is personal data transmission permission. If it is determined NO at S4, however, control proceeds directed to S6. At S6, it is determined if there is permission to transfer personal data. If it is determined YES at S7, then a request to start transferring person data is issued. Otherwise, if it is determined NO at S6, control passes to S8, and the data transferring process is performed after proceeding to next S8, thereby terminating the process.

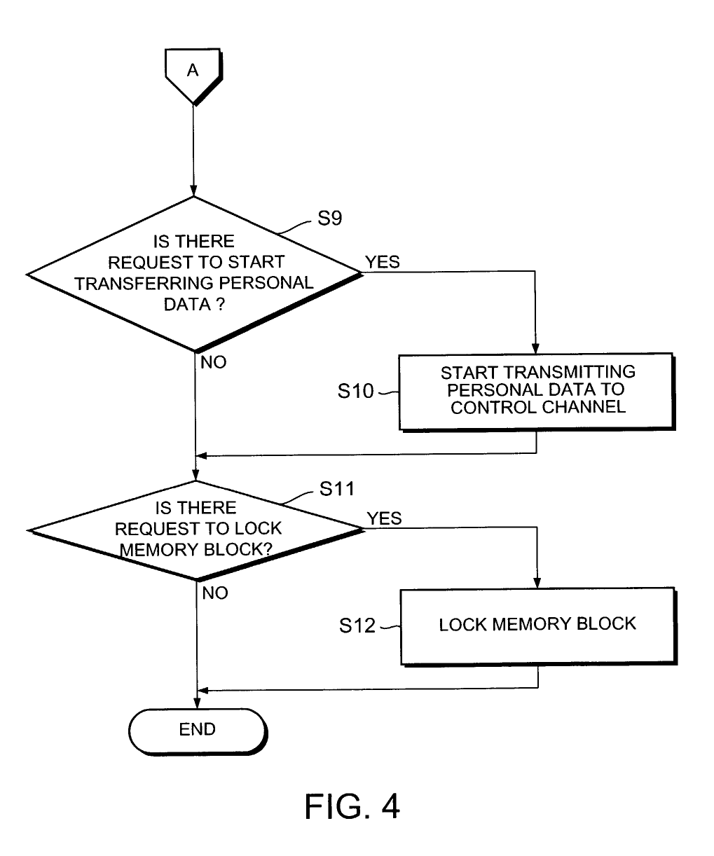

As shown in the flowchart in detail in FIG. 4, it is determined whether or not there is a request to start transfer of the personal data 16 in S9. If there is the request (YES), then control passes to S10, where the telephone book data, outgoing call history data, incoming call history data, and memo data stored in the personal data 16 is read by the control unit 10 and transmitted through the antenna 4, the radio unit 12 and the antenna 11 to the memory of the personal computer 7. The data is temporarily stored in the memory of the personal computer 7. Control is then passed to S11.

It is determined at S11 whether of not there is a request to lock the memory block 14. If there is the request (YES), then control is passed to S12, and the memory block 14 is locked, thereby terminating the process.

If it is determined in S9 that there is no request to start transferring the data (NO), then the above mentioned S11 and S12 are not performed.

Thus, outgoing call control is executed on the lost mobile phone 1, the unauthorized browsing of personal data is prohibited and the personal data is pulled from the lost mobile phone 1. Therefore, the third party having the lost mobile phone 1 cannot issue a call, and cannot browse personal data, thereby completely preventing an unauthorized use and unauthorized leakage of the personal data by the third party.

Furthermore, since the above mentioned preventing process is performed using the control channel without establishing a circuit of a communications channel, the process can be realized without waiting for a response to a call to the lost mobile phone 1. That is, it can be realized only if the lost mobile phone 1 bas been powered up and is located in the service area of the antenna 4, thereby realizing a perfect countermeasure.

If the lost mobile phone 1 has not been powered up yet, then it is powered up and simultaneously a call is automatically issued through a control channel circuit. Therefore, in response to the call, the base station 3 prepares data to remotely control the outgoing call control, the prohibition against unauthorized browsing of personal data, and the retrieval of personal data in advance. As a result, when the lost mobile phone 1 is powered up, the outgoing call control, the prohibition against browsing personal data, and the retrieval of personal data can be simultaneously performed.

On the other hand, as an example other than the above mentioned case in which the remove control is performed on the lost mobile phone 1 through the public line network 2 and the base station 3, the user 5 can perform remote control on the base station 3 using a mobile phone. In this case, a control code for execution of the outgoing call control, the prohibition against browsing personal data, and the retrieval of personal data is transmitted from the user 5s.

In this case, the retrieval of personal data can be directly performed if there is a sufficiently large memory capacity of the equipment. If there is no sufficiently large memory, the data is temporarily stored in the base station 3, and is fetched later using a personal computer or other communication devices

By allowing the personal computer 7 storing the personal data 16 fetched from the lost mobile phone 1 to be remotely controlled to be connected to the substitute mobile phone 8 with the connection cable 9 connected through a predetermined interface circuit and to execute the edit software of the data of the mobile phone built in the personal computer 7, the personal data 16 of the lost mobile phone 1 can be transferred as is in the substitute mobile phone 8, or in an edited state.

As a result, the personal data can be retrieved regardless of whether or not the lost mobile phone 1 is practically held at hand.

In the explanation above, the portable terminal device (lost mobile phone 1) comprises a first control means for exerting control over an outgoing call by controlling the radio means when a matching result is detected between the outgoing call control request data and the outgoing call control permission data. The portable terminal device comprises a second control means for transferring the personal data to a predetermined destination by controlling the radio means when a matching result is detected between the transfer request data and the transfer permission data. However, the portable terminal device can also be configured by comprising one of the first control means and the second control means.

The outgoing call control on the portable terminal device can function as software by directly prohibiting a call issuing operation, or can perform indirect prohibition by providing operation lock means for suppressing the key operation of issuing a call. Similarly, the prohibition against browsing personal data can function as software by directly prohibiting a browsing operation, or can perform indirect prohibition by providing data lock means for suppressing the key operation of browsing the personal data. The personal data pulled out from the portable terminal device (lost mobile phone 1) can be stored in the personal computer 7, directly stored in the substitute mobile phone 8, temporarily stored in the base station 3 and then fetched later, etc.

Furthermore, the permission data registered in advance in the lost mobile phone 1 for determination of the outgoing call control, the prohibition against browsing personal data, and the retrieval of personal data can be configured by including a telephone number and/or the equipment number or by a password at the discretion of the user.

Additionally, when the outgoing call control and/or data lock is performed, the contents can be displayed indicating “this phone is not available” or “please contact the owner XXX” on the display unit 13.

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A mobile terminal device comprising:
radio means for communicating communications channel data with a radio base station, and for communicating control channel data with said radio base station at an appropriate timing independent of said control channel data;
storing means for storing predetermined information;
judging means for judging whether said predetermined information is contained in said control channel data received by said radio means; and
controlling means for controlling said radio means on the basis of the result of said judging means.

2. The mobile terminal device as claimed in claim 1, wherein said controlling means prevents an outgoing call if said predetermined information is contained in said control channel data.

3. The mobile terminal device as claimed in claim 2, wherein said controlling means prohibits a key operation for issuing a call from said mobile terminal device.

4. The mobile terminal device as claimed in claim 3, wherein said predetermined information is the data that requests outgoing call control.

5. The mobile terminal device as claimed in claim 4, further comprising display means for displaying the contents of outgoing call control when it is performed.

6. A mobile terminal device comprising:
radio means for communicating communications channel data with a radio base station, and for communicating control channel data with said radio base station at an appropriate timing independent of said control channel data;
storing means for storing predetermined information and personal information;
judging means for judging whether said predetermined information is contained in said control channel data received by said radio means; and
controlling means for controlling said personal information on the basis of the result of said judging means.

7. The mobile terminal device as claimed in claim 6, wherein said controlling means transfers said personal information stored in said mobile terminal device if said predetermined information is contained in said control channel data.

8. The mobile terminal device as claimed in claim 7, wherein said personal information is transferred to a personal computer connected to at least one of a radio channel and a cable channel.

9. The mobile terminal device as claimed in claim 8, wherein said controlling means prohibits a key operation for reading said personal information.

10. The mobile terminal device as claimed in claim 9, further comprising display means for displaying contents of data locking when it is performed.

11. An outgoing call control method, comprising:
storing predetermined information;
communicating communications channel data with a radio base station;
communicating control channel data with said radio base station at an appropriate timing independent of said control channel data;
judging whether said predetermined information is contained in said control channel data; and
controlling an outgoing call if said predetermined information is contained in said control channel data.

12. The outgoing call control method as claimed in claim 11, wherein said controlling an outgoing call comprises prohibiting a key operation for issuing a call from said mobile terminal device.

13. The outgoing call control method as claimed in claim 12, wherein said predetermined information is the data that requests outgoing call control.

14. The outgoing call control method as claimed in claim 13, further comprising displaying contents of outgoing call control when it is performed.

15. A data transfer method, comprising:
storing predetermined information and personal information;
communicating communications channel data with a radio base station;
communicating control channel data with said radio base station at an appropriate timing independent of said control channel data;
judging whether said predetermined information is contained in said control channel data; and
transferring said personal information if said predetermined information is contained in said control channel data.

16. The data transfer method as claimed in claim 15, wherein said personal information is transferred to at least one of a personal computer connected to a radio channel and a cable channel.

17. The data transfer method as claimed in claim 16, further comprising prohibiting a key operation for reading said personal information.

18. The data transfer method as claimed in claim 17, further comprising displaying contents of data locking when it is performed.

19. A mobile terminal device comprising:
a radio unit that communicates communications channel data with a radio base station, and that communicates control channel data with said radio base station at an appropriate timing independent of said control channel data;
a memory that stores a predetermined information;
an analysis unit that judges whether said predetermined information is contained in said control channel data received by said radio unit; and
a control unit that controls said radio unit on the basis of the result of said analysis unit.

20. The mobile terminal device as claimed in claim 19, wherein said control unit controls an outgoing call if said predetermined information is contained in said control channel data.

21. The mobile terminal device as claimed in claim 20, wherein said control unit prohibits a key operation for issuing a call from said mobile terminal device.

22. The mobile terminal device as claimed in claim 21, wherein said predetermined information is the data that requests outgoing call control.

23. The mobile terminal device as claimed in claim 22, further comprising a display unit that displays contents of outgoing call control when it is performed.

24. A mobile terminal device comprising:
a radio unit that communicates communications channel data with a radio base station, and that communicates control channel data with said radio base station at an appropriate timing independent of said control channel data;
a memory that stores predetermined information and personal information;
an analysis unit that judges whether said predetermined information is contained in said control channel data received by said radio unit; and
a control unit that controls said personal information on the basis of the result of said analysis unit.

25. The mobile terminal device as claimed in claim 24, wherein said control unit transfers a personal information stored in said mobile terminal device if said predetermined information is contained in said control channel data.

26. The mobile terminal device as claimed in claim 25, wherein said personal information is transferred to at least one of a personal computer connected to a radio channel and a cable channel.

27. The mobile terminal device as claimed in claim 26, wherein said control unit prohibits a key operation for reading said personal information.

28. The mobile terminal device as claimed in claim 27, further comprising a display that displays contents of data locking when it is performed.
